(19) United States
(12) Patent Application Publication
(10) Pub. No.: US 2004/0235522 A1
(43) Pub. Date: Nov. 25, 2004

(54) Card facility for freely communicating with network systems

(76) Inventor: Alan Lin, Hsin Chuang City (TW)

Correspondence Address: Alan Lin, P.O. Box 4-67, Hsin Chuang, Taipei, 242, TW

(21) Appl. No.: 10/444,526

(22) Filed: May 21, 2003

(51) Int. Cl. H04M 1/00

(52) U.S. Cl. 455/558

(57) ABSTRACT

A network card facility includes a wireless card device for coupling to the electronic facility, a processor device for processing the signals from the electronic facility, a coupler for plugging an SIM card member, a memory coupled between the coupler and the processor device, and an antenna coupled to the processor device to communicate with the network system. The information of the SIM card member may be supplied and stored in the memory, and may be transmitted to an ISP, to allow end users to communicate with the network system again and again with various kinds of different electronic facility, at any other places or locations.

### BACKGROUND OF THE INVENTION

1. Field of the Invention

The present invention relates to a card facility, and more particularly to a wireless network card facility for allowing end users to freely communicate with various network systems without plugging and unplugging card members again and again.

2. Description of the Prior Art

Various kinds of network systems have become more and more popular nowadays. Heretofore, the computers of the end users are required to be coupled to or communicated with the network systems with or via cable connections. However, the cable connected network systems are inconvenient for both the end users and the network system providers.

Recently, wireless network systems have become more and more popular, and have mostly substituted the cable connected network systems. For entering into or for communicating with the wireless network systems, various kinds of wireless card members are required to be prepared and coupled to the computers of the end users, and include an antenna device for communicating with the wireless network systems.

For example, the end users may purchase and/or prepare a subscriber identify module (SIM) card member, to plug into either of the electronic facilities, such as portable or mobile phones, wireless network card devices, notebook computers, personal computers, personal digital assistants (PDAs), etc., in order to communicate with various wireless network systems.

However, the SIM card member have to be plugged into the portable or mobile phones when the end users are going to communicate with the wireless network systems with the portable or mobile phones.

The SIM card member have to be unplugged from the portable or mobile phones, and are then required to be plugged into the wireless network card devices, or notebook computers, or personal computers, or PDAs, or the like, when the end users are going to communicate with the wireless network systems with the wireless network card devices, or notebook computers, or personal computers, or PDAs, or the like.

Accordingly, it is inconvenient for end users to communicate with the wireless network systems with different kinds of electronic facilities, such as portable or mobile phones, wireless network card devices, notebook computers, personal computers, personal digital assistants (PDAs), or the like.

The present invention has arisen to mitigate and/or obviate the afore-described disadvantages of the conventional wireless network card facilities.

### SUMMARY OF THE INVENTION

The primary objective of the present invention is to provide a wireless network card facility for allowing end users to freely communicate with various network systems without plugging and unplugging card members again and again.

In accordance with one aspect of the invention, there is provided a network card facility for communicating an electronic facility of an end user with a network system, the wireless network card facility comprising a wireless card device including an interface for coupling to the electronic facility and for receiving and transmitting signals to and from the electronic facility, a processor device coupled to the interface for processing the signals from the interface, a coupler, a memory coupled between the coupler and the processor device, and an antenna coupled to the processor device to receive and to transmit signals to and from the network system, and an SIM card member for plugging to the coupler of the wireless card device, to provide an information of the SIM card member to the memory of the wireless card device. The memory and the antenna and the processor device of the wireless card device are provided to transmit the information of the SIM card member to an ISP of the network system, to allow the end user to communicate with the network system again without using or plugging the SIM card member to the electronic facility again, and to allow the end user may to easily communicate with or connect to the wireless network systems again and again with various kinds of different electronic facility, at any other places or locations.

The memory is preferably an erasable electrically programmable read only memory.

The wireless card device further includes a wireless circuit coupled between the antenna and the processor device to receive and convert wireless signals from the network systems into digital signals, and to send the digital signals to the processor device, and to receive and convert digital signals from the processor device into wireless signals, and to send the wireless signals to the network systems.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a schematic view of a wireless network card facility in accordance with the present invention, for use with an electronic facility, such as the notebook computer;

FIG. 2 is a plan view of the wireless network card facility;

FIG. 3 is a plan schematic view illustrating the operation of the wireless network card facility;

FIG. 4 is a flow chart illustrating the using of the SIM card member for the wireless network card facility;

FIG. 5 is a flow chart illustrating the communication of the end users with the wireless network card facility; and

FIG. 6 is a flow chart illustrating the deleting process of the information of the SIM card member from the wireless network card facility.

### DETAILED DESCRIPTION OF THE PREFERRED EMBODIMENT

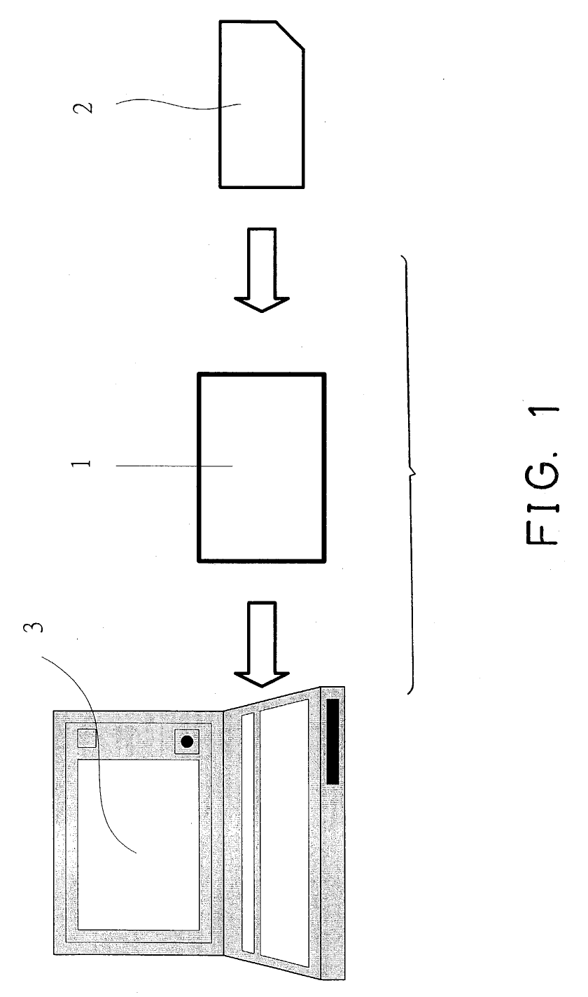

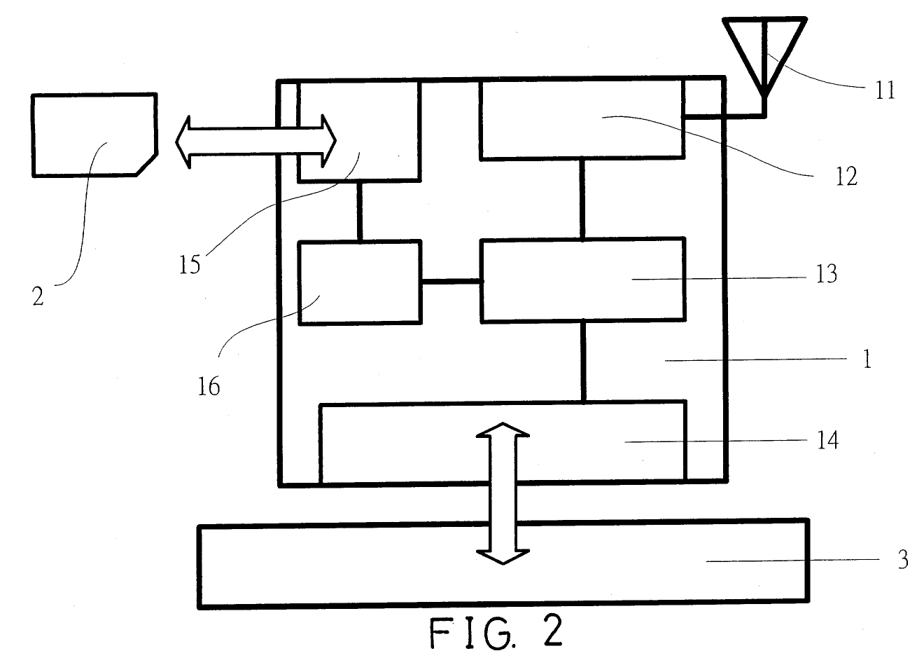

Referring to the drawings, and initially to FIGS. 1 and 2, a wireless network card facility in accordance with the present invention comprises a wireless card device 1 including an interface 14 for coupling to or for communicating with electronic facilities 3, such as notebook computers, portable or mobile phones, wireless network card devices, personal computers, personal digital assistants (PDAs), etc.

The interface 14 may be various kinds of interfaces 14, such as compact flash (CF) interface, personal computer memory card international association (PCMCIA) interface, universal serial bus (USB) interface, or the like, for coupling to or for communicating with various kinds of electronic facilities 3.

The wireless card device 1 further includes a microprocessor or a processing unit or a processor device 13 coupled to the interface 14, to receive and/or transmit and/or process various signals, data, information, or the like, to or from the interface 14 and the electronic facilities 3.

The wireless card device 1 further includes a wireless module or circuit 12 coupled to the processor device 13, and an antenna device 11 coupled to the wireless circuit 12. The antenna device 11 may be used to receive and transmit wireless signals between the wireless network systems 5 and the electronic facilities 3, such as various institute of electrical and electronic engineers (IEEE) signals, such as IEEE 802.11 signals.

The wireless circuit 12 is provided to receive and convert the wireless signals from the wireless network systems 5 into package or digital signals, and to send the package or digital signals to the processor device 13; or to receive and convert the package or digital signals from the processor device 13 into wireless signals, and to send the wireless signals to the wireless network systems 5. The wireless circuit 12 may thus be communicated between the wireless network systems 5 and the processor device 13 with the antenna device 11.

The wireless card device 1 further includes a socket or coupler 15 for plugging the SIM card member 2 thereto, and includes a memory 16, such as an erasable electrically programmable read only memory (EEPROM) 16 coupled between the coupler 15 and the processor device 13, to read and save or memorize the data or information of the SIM card member 2, such as the identifications, the passwords, the service set identifiers (SSID) or other information of the SIM card member 2.

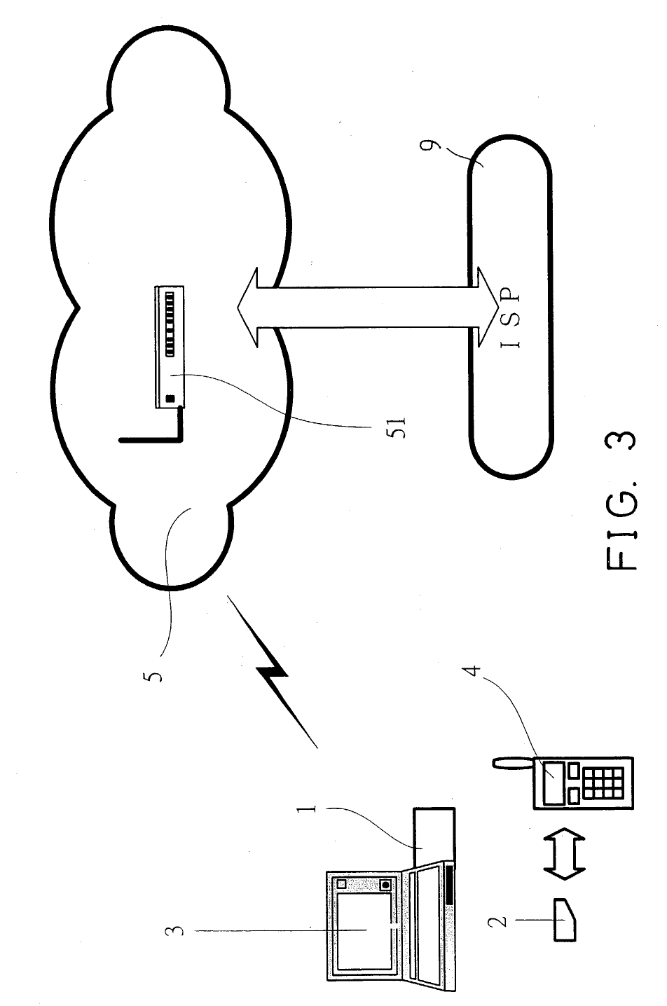

In operation, the wireless card device 1 may send the data or information of the SIM card member 2, that is stored or memorized in the memory 16, to the internet service provider (ISP) 9, via such as the access device 51 of the wireless network system 5 (FIG. 3).

The end users may then be communicated with the wireless network systems 5 with various electronic facilities 3, 4 with the data or information of the SIM card member 2, that has been provided to and stored or memorized in the ISP 9, without plugging and unplugging the SIM card member 2 to the coupler 15 of the wireless card device 1 again and again, and without plugging and unplugging the wireless card device 1 to different electronic facilities 3, 4 again and again.

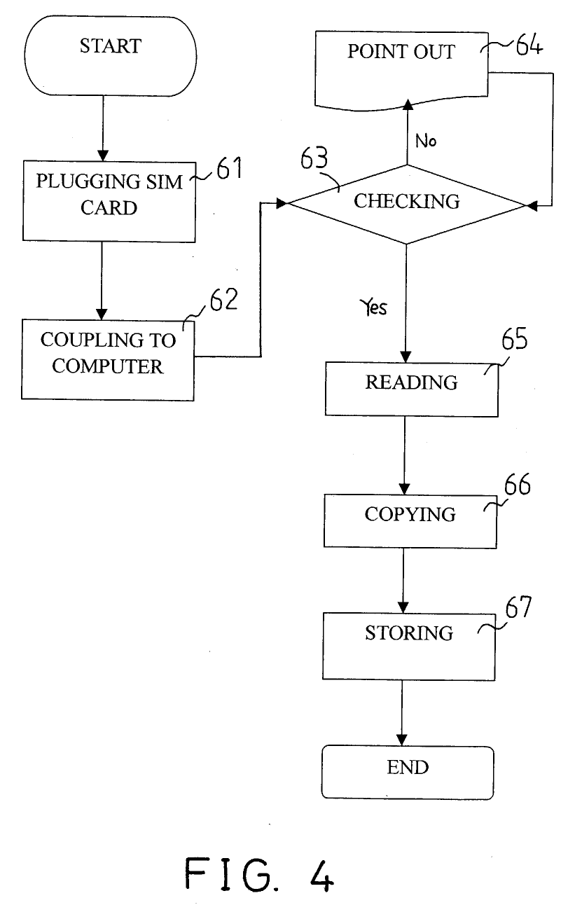

For example, as shown in FIG. 4, when a user is going to communicate with the wireless network systems 5 with an electronic facility 3, such as the notebook computer 3, the SIM card member 2 may first be plugged into the coupler 15 of the wireless card device 1 in process 61, and then the wireless card device 1 is plugged or coupled to the electronic facility 3 in process 62.

A process 63 will then be conducted to check whether the SIM card member 2 has been safely or correctly plugged into the coupler 15 of the wireless card device 1 or not. If the SIM card member 2 has been checked to be incorrectly plugged into the coupler 15 of the wireless card device 1, a pointing out process 64 may then be conducted to warn or to indicate or to guide the user to correctly plug the SIM card member 2 into the coupler 15 of the wireless card device 1 again, until the SIM card member 2 has been checked to be correctly plugged into the coupler 15 of the wireless card device 1.

In the checking process 63, when the SIM card member 2 has been checked to be correctly plugged into the coupler 15 of the wireless card device 1, a reading process 65 will then be conducted to read the data or information of the SIM card member 2, such as the identifications, the passwords, the SSIDs or other information of the SIM card member 2.

A copying process 66 will then be conducted to copy the data or information of the SIM card member 2, and another storing process 67 will then be conducted to store or to memorize the data or information of the SIM card member 2 in the memory 16, such as in the EEPROM 16, and then to wait for the communication of the end users with the wireless network systems 5.

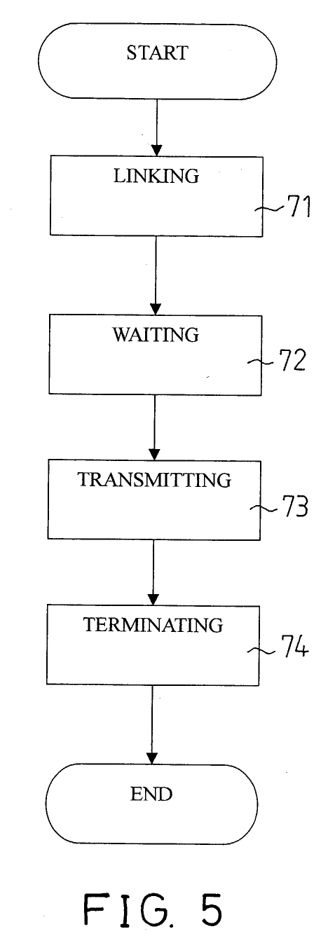

As shown in FIG. 5, when the user is communicating with or connecting to the wireless network systems 5 with the electronic facility 3, a linking process 71 will be conducted to couple or to link or to transmit signals from the electronic facility 3 to the access device 51 of the wireless network systems 5, such as to transmit the data or information of the SIM card member 2 in the memory 16 to the internet service provider (ISP) 9, via the access device 51 of the wireless network system 5 (FIG. 3).

A waiting process 73 will then be conducted to wait for the return confirmation message or information from the access device 51 of the wireless network system 5. When the access device 51 has sent a confirmation message or information to the wireless card device 1, the package or digital data or information may thus allowed to be transmitted from the wireless card device 1 to the wireless network system 5 in process 73, until the transmission between the wireless card device 1 and the wireless network system 5 has been terminated in process 74.

After the data or information of the SIM card member 2 in the memory 16 has been transmitted to the ISP 9 once, the end users may then be then be communicated with or connected to the wireless network systems 5 with the electronic facility 3 or the other electronic facilities 4 (FIG. 3), such as the portable or mobile phones, the personal computers, or PDAs, or the like, without plugging the SIM card member 2 into the wireless card device 1 again.

The ISP 9 may calculate or count the linking time and/or the fees required or consumed by the end users, by the previously data or information of the SIM card member 2 that has been transmitted to the ISP 9.

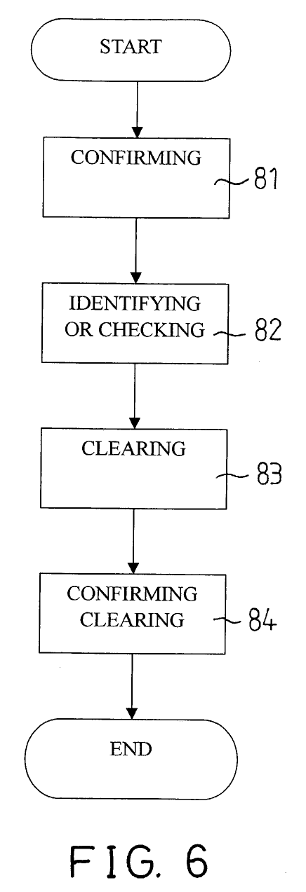

As shown in FIG. 6, when the user is no longer or not required to be communicated with or connected to the wireless network systems 5, a confirming process 81 will be conducted to send a message to the electronic facility 3 of the end user, and to wait for the end user to confirm that he is no longer or not required to be communicated with or connected to the wireless network systems 5 again.

When the end user has confirmed that he is no longer or not required to be communicated with or connected to the wireless network systems 5 again, an identifying or checking process 82 will then be conducted to check or the examine or the identify the message or the data or information of the SIM card member 2 in the ISP 9, and/or the linking time and/or the fees required by the end users.

After the message or the data or information of the SIM card member 2 in the ISP 9, and/or the linking time and/or the fees required by the end users has been checked or examined or identified by the user, a clearing process 83 will then be conducted to clear the message or information or the data or information of the SIM card member 2 in the ISP 9, and a confirming clearing process 84 will then be conducted to send a clearing completion message to the electronic facility 3 of the end user, and to wait for the end user to confirm that the clearing is OK to him.

It is to be noted that, once the data or information of the SIM card member 2 has been transmitted from the memory 16 of the wireless card device 1 to the ISP 9, the user may then be easily communicated with or connected to the wireless network systems 5 easily with various kinds of different electronic facility 3, at any other places or locations.

Accordingly, the wireless network card facility in accordance with the present invention may be provided for allowing end users to freely communicate with various network systems without plugging and unplugging card members again and again.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A network card facility for communicating an electronic facility of an end user with a network system, said wireless network card facility comprising:
a) a wireless card device including:
i) an interface for coupling to the electronic facility and for receiving and transmitting signals to and from the electronic facility,
ii) a processor device coupled to said interface for processing the signals from said interface,
iii) a coupler,
iv) a memory coupled between said coupler and said processor device, and
v) an antenna coupled to said processor device to receive and to transmit signals to and from the network system, and
b) an SIM card member for plugging to said coupler of said wireless card device, to provide an information of said SIM card member to said memory of said wireless card device,
said memory and said antenna and said processor device of said wireless card device being provided to transmit the information of said SIM card member to an ISP of the network system, to allow the end user to communicate with the network system again without using or plugging said SIM card member to the electronic facility again.

2. The wireless network card facility as claimed in claim 1, wherein said memory is an erasable electrically programmable read only memory.

3. The wireless network card facility as claimed in claim 1, wherein said wireless card device further includes a wireless circuit coupled between said antenna and said processor device to receive and convert wireless signals from the network systems into digital signals, and to send the digital signals to said processor device, and to receive and convert digital signals from said processor device into wireless signals, and to send the wireless signals to the network systems.
